(19) United States
(12) Patent Application Publication
(10) Pub. No.: US 2015/0083265 A1
(43) Pub. Date: Mar. 26, 2015

(54) SELF-ILLUMINATING TUBING

(71) Applicant: John Thomas Waldrip, Salt Lake City, UT (US)

(72) Inventor: John Thomas Waldrip, Salt Lake City, UT (US)

(21) Appl. No.: 14/496,530

(22) Filed: Sep. 25, 2014

Related U.S. Application Data
(60) Provisional application No. 61/882,903, filed on Sep. 26, 2013.

(51) Int. Cl. F16L 9/14; F21V 33/00; F16L 11/04; F21V 9/16

(52) U.S. Cl. CPC F16L 9/14; F21V 9/16; F21V 33/00; F21V 33/0068; F16L 11/04; F21W 2131/40
USPC 138/146

(57) ABSTRACT

The disclosure provides self-illuminating tubing that may be uncoupled from external power sources. The disclosed tubing is useful in a variety of low-light environments. Applications include medical devices and tubing for use in building construction and for industrial purposes. Embodiments in which the illuminating material indicates where tubing has been damaged are also disclosed.

### RELATED APPLICATIONS

This application claims priority to U.S. Provisional Application No. 61/882,903 filed on Sep. 26, 2013 and titled “Self-Illuminating Tubing,” which is hereby incorporated by reference in its entirety.

### SUMMARY OF THE INVENTION

The disclosure comprises self-illuminating tubing that is visible in dark or minimally-lighted areas without the use of an external source of electricity or other power. The self-illuminating tubing may be used in many ways, including medical, industrial, and residential applications.

### BRIEF DESCRIPTION OF THE DRAWINGS

FIG. 1A illustrates self-illuminating tubing that is illuminated throughout the circumference of the tubing.

FIG. 1B illustrates self-illuminating tubing that is illuminated on a portion of the circumference of the tubing.

FIG. 2A illustrates a cross section of self-illuminating tubing that comprises the illuminating material throughout the circumference of an outer layer.

FIG. 2B illustrates a cross section of self-illuminating tubing that comprises the illuminating material on a portion of the circumference of an outer layer.

FIG. 2C illustrates a cross section of self-illuminating tubing wherein the illuminating material is located between two concentric layers of the tubing.

FIG. 2D illustrates a cross section of self-illuminating tubing wherein the illuminating material is located on a portion of the circumference of an inner layer of tubing.

FIG. 3 illustrates three different segments of self-illuminating tubing, shaded to represent color coding for the different liquids or gases conveyed by the tubing.

### DETAILED DESCRIPTION

Slips, trips, and falls are common safety problems in the home, in health care facilities, and in work areas. A source of these accidents is entanglement in tubing of a variety of types. Tubing is often difficult to see in dark areas and illumination of the tubing that requires an external source of power is often impractical or inefficient. Self-illuminating tubing is needed to make tubing visible in dark or dimly-lighted areas without the need for an external power source.

Tubing, such as medical tubing, is often constructed of transparent polymer so that users, including health care workers, may view the contents through the walls of the tubing. This transparent design makes such tubing especially difficult to see in low light. Self-illuminating tubing, as disclosed herein, is useful because it is visible in dark or minimally-lighted areas and does not require the use of an external source of electricity or other power. It is, therefore, more portable. The lack of power cords makes it less cumbersome as well as useful in areas where an outside power source would be impractical. Such tubing reduces the potential for accidents caused by tripping on or becoming entangled in the tubing, thus preventing injury from falls. Furthermore, prevention of accidental entanglement in medical tubing may also prevent adverse medical events resulting from displacement of medical devices that are connected to the tubing. The present disclosure describes tubing that is illuminated without the use of an external power source, thus making the tubing visible to patients and caregivers in areas of little or no light.

Tubing is also used in enclosed areas of buildings and underground where there is little or no light. Such tubing may be in the form of plumbing, coverings for electrical wires, or ductwork. The inability to clearly see such tubing creates difficulties in construction and repair. Self-illuminating tubing would be useful to workers and homeowners in the process of installing or repairing the tubing, or an apparatus related to or including the tubing, in dark or minimally-lighted areas. The present disclosure describes tubing that is illuminated without the use of an external power source which makes the tubing visible and identifiable to construction workers or to homeowners conducting building improvement or repair tasks. By making the tubing visible, the tubing is more easily manipulated and the user may be assured that the correct tubing is being repaired or installed.

The tubing may be constructed of a variety of materials and by using a variety of methods known to those in the art. Examples of materials that may be used to construct the tubing include polymers, copolymers, metals, metal alloys, concrete, clay, and ceramic. Techniques for constructing the tubing may include extrusion, metallurgical techniques, and molding. The tubing may be produced in a variety of lengths and diameters according to the use of the tubing as known in the relevant art.

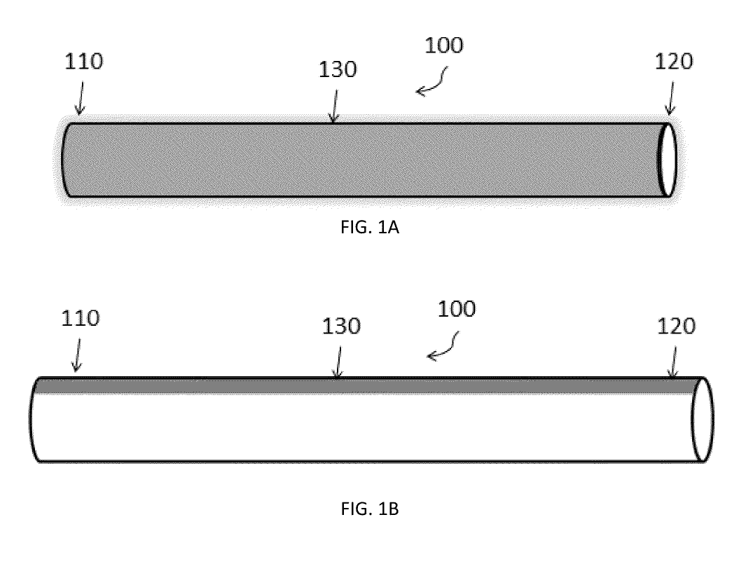

As one of skill in the art will readily understand, the term tubing, as used herein, means a structure as illustrated in FIGS. 1A and 1B comprising an elongated structure 100 that comprises a first end 110 and a second end 120. Between the first end 110 and the second end 120 is a central portion 130. The elongated structure 100 may be cylindrical, prism-shaped, or comprise of another elongated shape with a cross section that comprises of a square, rectangle, or other polygon. The tubing comprises an elongated wall that defines an interior channel through which substances, including, but not limited to, liquids, gases, and wires may move or be housed. The elongated wall also defines an exterior surface of the tubing. The tubing may be flexible or inflexible. As used herein, the term tubing is used synonymously with other structures that fit the definition as disclosed herein such as pipes, piping, pipelines, channels, ducts, tubes, and conduits. As illustrated in FIG. 1A, the illuminating material, depicted in gray, may be present throughout the circumference of the tubing. Alternatively, as illustrated in FIG. 1B, the illuminating material, depicted in gray, may be present on or in only a part of the tubing such as a portion of the circumference. The embodiment as shown in FIG. 1B allows the tubing to maintain a transparent portion so that the contents of the tubing may be readily visualized.

In one embodiment, the tubing is made to be self-illuminating by applying the illuminating material to the outer surface of the tubing after the tubing is formed using a known technique such as dipping, painting or spraying.

In another embodiment, the illuminating material is mixed into the material that will later be used to construct the tubing. For example, the illuminating material may be mixed into a liquid polymer or copolymer solution before it is extruded or molded to form tubing. In this embodiment, the illuminating material is present throughout the thickness of the tubing wall.

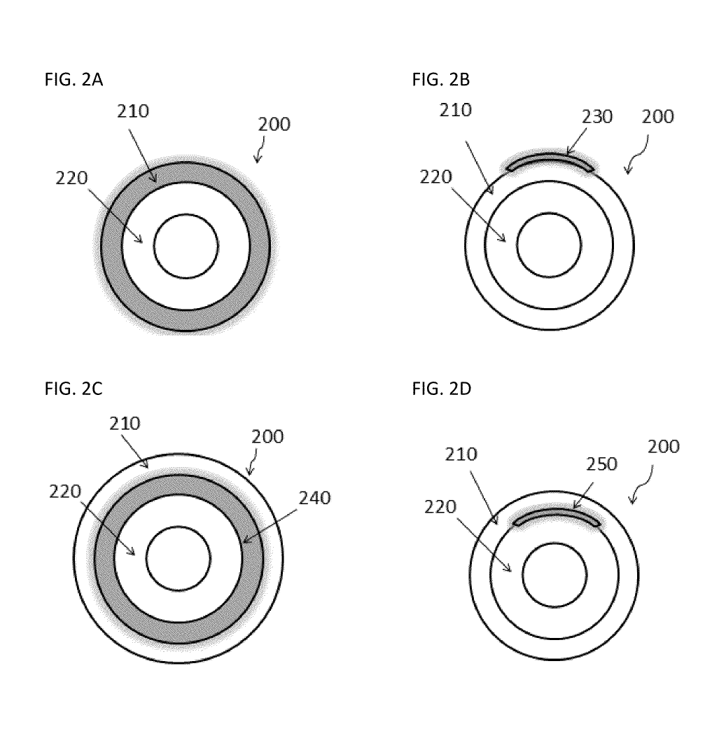

In still another embodiment, the tubing has two or more concentric layers. wherein at least one layer comprises the illuminating material. In various embodiments, the illuminating material is on an inner surface of one or more of the concentric layers, an outer surface of one or more of the concentric layers, or within the material used to construct one or more of the layers. In addition, the illuminating material may be absent from one or more additional layers that comprise the tubing. FIGS. 2A, 2B, 2C, and 2D illustrate examples of such embodiments. Alternatively, the tubing may comprise of multiple layers of illuminating material. Furthermore, the illuminating surface may be present in various patterns on the tubing or in a continuous or gapped configuration.

In FIG. 2A, the tubing 200 is comprised of an outer layer 210 and an inner layer 220. The inner layer 210 and the outer layer 220 may be comprised of the same or different materials. The outer layer 210 comprises the illuminating material while the inner layer 220 does not. Such an embodiment may be useful for applications where it is undesirable for the illuminating material to come in contact with or in close proximity to the contents of the tubing. In FIG. 2A, the entire circumference of the outer layer 210 comprises the illuminating material. As illustrated in FIG. 2B, the illuminating material may be present on only a portion of the outer layer 210. FIG. 2B includes a section 230 of the circumference of the outer layer 210 that comprises the illuminating material leaving the remainder of the outer layer 210 and the entire inner layer 220 without the illuminating material. As with the embodiment of FIG. 2A, an embodiment such as that illustrated in FIG. 2B may be useful in situations wherein it is undesirable for the illuminating material to come in contact with or close proximity to the contents of the tubing. The embodiment of FIG. 2B may also be useful when it is desirable for a portion of the tubing to be fully or partially transparent. Alternatively, the illuminating material may be positioned between concentric layers that comprise the tubing. This design has the advantage of keeping the contents of the tubing out of contact with the illuminating material but has the added advantage of protecting the illuminating material from the environment external to the tubing. In one such embodiment, the illuminating material adheres to the outer surface of the inner layer 220 of tubing as illustrated in FIG. 2C. More specifically, there is a center layer 240 between inner layer 220 an outer layer 210 that comprises the illuminating material. Placing the illuminating material within the transparent or translucent tubing prevents the material being housed or transported within the tubing from being exposed to the illuminating material. In addition, the outer layer 210 protects the illuminating material from the external environment thus preventing or slowing damage to the illuminating material. Consequently, the external environment does not compromise the performance of the illuminating material. This design also allows thorough cleaning of the tubing interior and exterior without compromising the performance of the illuminating material. In one embodiment, illustrated in FIG. 2D, the illuminating material 250 is present in a section of the circumference of the inner layer of material 220. This prevents the substance being housed or transported within the tubing from being exposed to the illuminating material and allows cleaning the tubing interior and exterior without compromising the performance of the illuminating material. At the same time, when the tubing is comprised of a transparent material, the embodiment shown in FIG. 2D allows visualization of the contents of the tubing, similar to the tubing shown in FIGS. 1B and 2B.

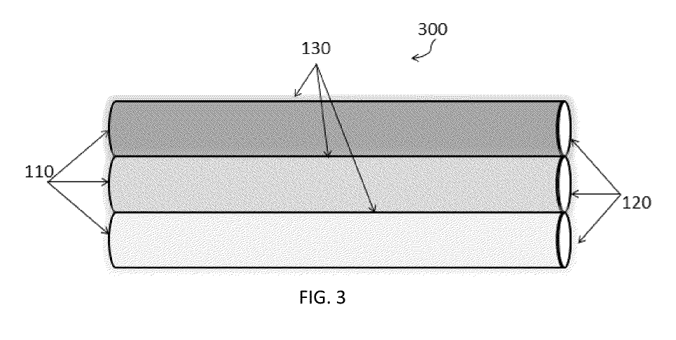

The illuminating material may emit light of a variety of colors, depending on the type of illuminating material and/or its chemical composition. The different colors may be used to identify the type of tubing and/or to identify the contents of the tubing. FIG. 3 illustrates the use of multiple sections of tubing, each emitting a different color of light. This is analogous to the use of different colored rubber or plastic to coat different electrical wires in order to identify each wire. In situations where light is minimal or absent, such as during a power outage or inside machinery, buildings, or underground tunnels, workers may readily identify the different types of tubing according to the color of light that the tubing emits. Furthermore, tubing may be color coded with self-illuminating material of a specific color according to the contents of the tubing. Such color coding would prevent errors due to inability to clearly see the tubing in low light. For example, a device that uses tubing to transport both oxygen and nitrogen may include tubing that illuminates a blue color for the oxygen tubing and tubing that illuminates a yellow color for the nitrogen tubing. Industry standards could potentially be defined that associate specific colors of illumination with specific contents. By using different colors to define the contents of the tubing, accidents such as delivering the wrong medically useful substance to a patient or into a machine or building could be avoided.

In one embodiment, the illuminating material is a photoluminescent material. Addition of photoluminescent material to the tubing allows the tubing to emit light after the absorption of light or other radiation. The two common examples are fluorescent material and phosphorescent material. Phosphorescent materials are used commonly in a variety of applications and may be combined with fluorescent materials to provide additional utility in different environmental conditions. The use of phosphorescent material allows the tubing to be self-illuminating for a period of time, in some instances up to, including, or exceeding 12 hours or more without being subject to external light in situations where the lights are turned off or power is lost.

Examples of phosphorescent materials that may be used to construct the self-illuminating tubing disclosed herein are provided in Table 1 along with the colors of light the materials emit.

TABLE 1
Example Phosphorescent Materials and Their Colors

| Material | Color |
|---|---|
| Silica Aluminate | green-yellow to purple-blue |
| Strontium Aluminate | green-yellow to purple-blue |
| Aluminate with Fluorescent Pigment | orange |
| Alkaline Earth Silicate | blue |
| Zinc Sulfide | green, red, or orange |

In one embodiment, the illuminating material is a chemiluminescent material. Addition of chemiluminescent material to the tubing allows the tubing to emit light resulting from a chemical reaction. Common forms are bioluminescence (light emitted by a biochemical reaction related to a living organism) and electrochemiluminescence (light produced by a chemical reaction in a solution).

Examples of illuminating chemical reactions include luminol in an alkaline solution with hydrogen peroxide in the presence of iron or copper, white phosphorous oxidizing in moist air, and ozone mixed with nitric acid.

These reactions may be useful in areas subject to severe stresses, such as seismic prone areas. Rapid acceleration could shatter containers of reactive chemicals internal to the tubing, resulting in illumination of areas damaged by the stress event.

In one embodiment, the illuminating material is crystalloluminescent material. Crystalloluminescence is a type of luminescence generated during crystallization, and is sometimes used to determine the critical size of the crystal nucleus. Crystalloluminescence is a type of triboluminescence and a subtype of electroluminescence. Addition of crystalloluminescent material to the tubing, using methods disclosed herein, allows production of light by certain substances as they crystalize from a solution. Electrically charged micro-fractures may be developed as crystalloluminescence occurs due to multiple processes such as the movement of charged dislocations, piezoelectrification, etc.

In one embodiment, the illuminating material is electroluminescent material. Adding electroluminescent material to the tubing allows the production of light by passing an electric current through the tubing or placing the tubing in a strong electrical field.

Alternatively, a hand held or remotely controlled magnetic field may be used to cause the tubing to glow, allowing for location and evaluation of the tubing in darkened areas. Electroluminescent materials include zinc sulfide with copper or silver, zinc sulfide with manganese, natural blue diamond with boron, semiconductors with indium phosphide, gallium arsenide, and gallium nitride, and certain organic semiconductors.

In other embodiments, the illuminating material comprises at least one mechanoluminescent material. Adding mechanoluminescent material to the tubing allows light production caused by mechanical action on a solid. Some varieties are triboluminescent material (light is produced when bonds are broken by scratching, crushing, or rubbing), fractoluminescent material (light is produced when a physical fracture causes charge separation and there is an electrical discharge across the gap), piezoluminescent material (light is produced by putting pressure on solids), and sonoluminescent material (light is produced in liquid when bubbles are imploded by sound energy). Examples of mechanoluminescent materials include diamonds, which may begin to glow blue-red while being rubbed, and other minerals, such as quartz, that are triboluminescent, emitting light when rubbed together. In yet another example of mechanoluminescence, tiny electrical fields are created as sugar crystals are crushed, separating positive and negative charges that then create sparks while trying to reunite.

Tubing that comprises mechanoluminescent material would enable detection of the tubing after it has been stressed and strained because of structural offset and damage, such as by an accident or tectonic activity after the event. A shock to the tubing of sufficient magnitude may cause impacted areas in the tubing to produce light, allowing identification of the stressed or damaged portions. Such tubing may be calibrated to indicate different magnitudes of stress on the tubing.

In another embodiment, the illuminating material comprises at least one fractoluminescent material. Fractoluminescent material, as used herein, is material which emits light from the fracture rather than by rubbing of a crystal, although fracturing often occurs with rubbing. This phenomenon can be demonstrated by removing ice from a freezer in a darkened room, under conditions in which the ice makes cracking sounds from sudden thermal expansion. If the ambient light is dim enough, flashes of white light from the cracking ice can be observed.

In yet another embodiment, the illuminating material comprises at least one piezoluminescent material. Piezoluminescent material, as used herein, is material which emits light as a result of a form of luminescence created by pressure upon certain solids. Handheld cigarette lighters (when the button is pressed), sodium chloride, potassium chloride, potassium bromide, and polycrystalline chips of lithium fluoride (TLD-100) all exhibit piezoluminescent properties. Furthermore, ferroelectric polymers exhibit piezoluminescence upon the application of stress.

In still another embodiment, the illuminating material comprises at least one sonoluminescent material. Sonoluminescent material, as used herein, is material which emits light as a result of the emission of short bursts of light from imploding bubbles in a liquid when excited by sound.

In one embodiment, the illuminating material comprises at least one radioluminescent material. Adding radioluminescent material to tubing may allow light production when the tubing is bombarded by ionizing radiation, such as alpha, beta, or gamma particles.

A mixture of radium and copper-doped zinc sulfide, which gives off a greenish glow, may be used as an illuminating material to construct self-illuminating tubing as disclosed herein. Phosphors containing copper-doped zinc sulfide (ZnS:Cu) yield blue-green light; copper and manganese-doped zinc sulfide (ZnS:Cu,Mn), yielding yellow-orange light, may also be used to construct self-illuminating tubing as disclosed herein.

In one embodiment, addition of radioluminescent material may allow tubing to be detected using an ionizing radiation emitter, either manually or remotely controlled.

In one embodiment, the illuminating material comprises at least one thermoluminescent material. Addition of thermoluminescent material to the tubing allows reemission of absorbed energy from electromagnetic radiation or other ionizing radiation as light when the material is subjected to heat.

The self-illuminating material may comprise of one or more of silica aluminate, strontium aluminate, aluminate with fluorescent pigment, alkaline earth silicate, zinc sulfide, calcite, amber, rubies, diamonds, emeralds, willemite, esperite, wollastonite, clinohedrite, hexavalent uranium, divalent manganese, trivalent chromium, trivalent lanthanides, divalent europium, tungsten-molybdenum in solid solution, sphalerite, crude oil, anthracene, stilbene, vitamin B2, tonic water, fluorite, luminol in alkaline solution with hydrogen peroxide in the presence of iron or copper, white phosphorous in moist air, ozone mixed with nitric acid, zinc sulfide with copper or silver or manganese, natural blue diamond with boron, semiconductors with indium phosphide, gallium arsenide, gallium nitride, quartz, pressure sensitive tape, sugar crystals, cracking ice, sodium chloride, potassium chloride, potassium bromide, polycrystalline chips of lithium fluoride, ferroelectric polymers, radium, copper-doped zinc sulfide, copper, manganese-doped zinc sulfide, uranium, thorium, potassium, rubidium, hand-held cigarette lighters, and lithium chloride.

The self-illuminating tubing disclosed herein may be used to convey a variety of gases and liquids, including, but not limited to, water, saline solution, medications, air, medical air, oxygen, nitrogen, helium, carbon dioxide, fuel, and coolant.

In industrial areas, such as confined spaces, self-illuminated tubing may be particularly useful to safely convey materials because of the loss of lighting when the power fails or is shut off.

It will be apparent to one skilled in the art that varying substitutions and modifications may be made to the subject matter disclosed herein without departing from the scope and spirit of the disclosure.

It will be apparent to those skilled in the art that the aspects and embodiments of the disclosure set forth herein may be practiced separate from each other or in conjunction with each other. Therefore, combinations of separate embodiments are within the scope of the disclosure as provided herein.

The embodiments illustratively described herein suitably may be practiced in the absence of any element or elements, limitation or limitations which is not specifically disclosed herein. The terms and expressions which have been employed are used as terms of description and not of limitation, and there is no intention that the use of such terms and expressions indicates the exclusion of equivalents of the features shown and described or portions thereof. It is recognized that various modifications are possible within the scope of the disclosure. Thus, it should be understood that although the present disclosure has been specifically illustrated by embodiments and optional features, modification and variation of the concepts herein disclosed may be resorted to by those skilled in the art, and that such modifications and variations are considered to be within the scope of this disclosure.

I claim:

1. A self-illuminated tubing, comprising:
an elongate wall defining an interior channel for transporting a substance, and defining an exterior surface of the tubing, the elongate wall comprising a first end, a second end, and a central portion between the first and second ends; and
a self-illuminating material that is disposed on or within the elongate wall.

2. The self-illuminating tubing according to claim 1, wherein the self-illuminating tubing is configured for use as medical tubing.

3. The self-illuminating tubing according to claim 1, wherein the self-illuminating material comprises a phosphorescent material.

4. The self-illuminating tubing according to claim 3, wherein the self-illuminating material comprises one or more of silica aluminate, strontium aluminate, aluminate with fluorescent pigment, alkaline earth silicate, and zinc sulfide.

5. The self-illuminating tubing according to claim 1, further comprising one or more concentric layers of tubing.

6. The self-illuminating tubing according to claim 1, wherein the self-illuminating tubing is configured for use as industrial tubing.

7. The self-illuminating tubing according to claim 1, wherein the self-illuminating tubing is configured for use as household tubing.

8. The self-illuminating tubing according to claim 1, wherein the self-illuminating material comprises a fluorescent material.

9. The self-illuminating tubing according to claim 8, wherein the illuminating material comprises one or more of calcite, amber, rubies, diamonds, emeralds, willemite, esperite, wollastonite, clinohedrite, hexavalent uranium, divalent manganese, trivalent chromium, trivalent lanthanides, divalent europium, tungsten-molybdenum in solid solution, sphalerite, crude oil, anthracene, stilbene, vitamin B2, tonic water, and fluorite.

10. The self-illuminating tubing according to claim 1, wherein the self-illuminating material comprises a chemiluminescent material.

11. The self-illuminating tubing according to claim 10, wherein the self-illuminating material comprises one or more of luminol in alkaline solution with hydrogen peroxide in presence of iron or copper, white phosphorous in moist air, and ozone mixed with nitric acid.

12. The self-illuminating tubing according to claim 1, wherein the self-illuminating material comprises a crystalloluminescent material.

13. The self-illuminating tubing according to claim 1, wherein the self-illuminating material comprises an electroluminescent material.

14. The self-illuminating tubing according to claim 13, wherein the self-illuminating material comprises one or more of zinc sulfide with copper or silver, zinc sulfide with manganese, natural blue diamond with boron, semiconductors with indium phosphide, gallium arsenide, and gallium nitride.

15. The self-illuminating tubing according to claim 1, wherein the self-illuminating material comprises a mechanoluminescent material.

16. The self-illuminating tubing according to claim 15, wherein the self-illuminating material comprises one or more of quartz, pressure sensitive tape, sugar crystals, cracking ice, sodium chloride, potassium chloride, potassium bromide, polycrystalline chips of lithium fluoride, and ferroelectric polymers.

17. The self-illuminating tubing according to claim 1, wherein the self-illuminating material comprises a radioluminescent material.

18. The self-illuminating tubing according to claim 17, wherein the self-illuminating material comprises one or more of radium, copper-doped zinc sulfide, copper, and manganese-doped zinc sulfide.

19. The self-illuminating tubing according to claim 1, wherein the self-illuminating material comprises a thermoluminescent material.

20. The self-illuminating tubing according to claim 19, wherein the self-illuminating material comprises one or more of uranium, thorium, potassium, rubidium, lithium chloride, and sodium chloride.
